(19) United States
(12) Patent Application Publication
(10) Pub. No.: US 2013/0228073 A1
(43) Pub. Date: Sep. 5, 2013

(54) METHODS AND APPARATUSES FOR COOLING AND SCRUBBING DIESEL EXHAUST GASES ON A SHIP

(71) Applicants: Ronald G. Patterson, (US); Andrew J. Olds, (US)

(72) Inventors: Ronald G. Patterson, (US); Andrew J. Olds, (US)

(21) Appl. No.: 13/412,431

(22) Filed: Mar. 5, 2012

(51) Int. Cl. B01D 47/06; B01D 53/14; B01D 47/14

(52) U.S. Cl. 95/187; 95/227; 95/211; 261/138

(57) ABSTRACT

Methods and apparatuses for scrubbing diesel exhaust gases produced on a ship are provided. In an embodiment, a method for scrubbing diesel exhaust gases on a ship includes providing a scrubber vessel formed with a quench zone, a scrubbing zone, and a riser. Water is passed through the scrubbing zone and into the quench zone. The exhaust gases are delivered to the quench zone through the riser and enter the quench zone at a temperature of about 175° C. to about 340° C. The method includes cooling the exhaust gases to a temperature of about 60° C. to about 70° C. in the quench zone by contacting the exhaust gases with the water. The cooled exhaust gases are then scrubbed in the scrubbing zone.

### TECHNICAL FIELD

The present disclosure generally relates to methods and apparatuses for scrubbing diesel exhaust gases, and more particularly relates to scrubbing methods and apparatuses that first cool the exhaust gases in a scrubbing vessel.

### BACKGROUND

As is well known, the combustion of hydrocarbon-containing fuels, such as diesel, results in exhaust gases containing sulfur compounds including sulfur dioxide. Further, the presence of sulfur dioxide in the atmosphere has been linked to the formation of acid rain. Due to the ecological damage resulting from acid rain, various government standards have been established to reduce or prevent the emission of sulfur dioxide.

While land-based combustion plants have utilized a variety of methods to reduce or eliminate the emission of sulfur dioxide, many of these methods are inappropriate for shipboard plants. For instance, land-based scrubbing apparatuses largely can be designed and implemented without, or with little, concern regarding footprint size. However, there is an overriding interest in minimizing the footprint of ship-based scrubbers and other power and exhaust systems. Further, there is an interest in optimizing fuel and exhaust processing systems on ships.

In light of the above, the present disclosure provides a method and apparatus for scrubbing exhaust gases on a ship with a reduced footprint. Further, the present disclosure provides a method and apparatus for quenching exhaust gases to saturation temperatures to improve mass transfer during scrubbing. Also, the present disclosure provides a method and apparatus for scrubbing cooled exhaust gases to reduce the cost of downstream equipment. Furthermore, the present disclosure provides a method and apparatus for scrubbing exhaust gases that exhibits a reduced pressure drop on the diesel engine. Alternative or additional features and characteristics of the methods and apparatuses will become apparent from the subsequent detailed description and the appended claims, taken in conjunction with the accompanying drawings and this background.

### BRIEF SUMMARY

Methods and apparatuses for scrubbing diesel exhaust gases produced on a ship are provided. In accordance with one exemplary embodiment, a method for scrubbing diesel exhaust gases on a ship includes providing a scrubber vessel formed with a quench zone, a scrubbing zone, and a riser. Water is passed through the scrubbing zone and into the quench zone. The exhaust gases are delivered to the quench zone through the riser and enter the quench zone at a temperature of about 175° C. to about 340° C. The method includes cooling the exhaust gases to a temperature of about 60° C. to about 70° C. in the quench zone by contacting the exhaust gases with the water. The cooled exhaust gases are then scrubbed in the scrubbing zone.

In another embodiment, a method for scrubbing diesel exhaust gases produced on a ship includes flowing the exhaust gases from a diesel engine to a scrubber vessel. The exhaust gases are introduced to a chamber within the scrubber vessel and have a temperature of about 175° C. to about 340° C. Then the exhaust gases are cooled to a temperature of about 60° C. to about 70° C. Thereafter, the cooled exhaust gases are scrubbed.

In accordance with another exemplary embodiment, an apparatus for scrubbing diesel exhaust gases produced on a ship is provided. The apparatus includes a scrubber vessel formed with a quench zone, a scrubbing zone, and a riser. Further, a duct is configured to deliver the exhaust gases through the riser and into the quench zone at a temperature of about 175° C. to about 340° C. The apparatus includes a means for cooling the exhaust gases to about 60° C. to about 70° C. in the quench zone. Also, the apparatus includes a means for scrubbing the cooled exhaust gases in the scrubbing zone.

### BRIEF DESCRIPTION OF THE DRAWINGS

Exemplary embodiments will hereinafter be described in conjunction with the following drawing figures, wherein like numerals denote like elements, and wherein:

FIG. 1 is a schematic view of an apparatus for scrubbing exhaust gases on a ship in accordance with exemplary embodiments;

FIG. 2 is a cross sectional view of a scrubber vessel for use in the apparatus of claim 1 in accordance with exemplary embodiments;

FIG. 3 is a cross sectional view of an alternate scrubber vessel for use in the apparatus of claim 1 in accordance with exemplary embodiments; and

FIG. 4 is a perspective view of water stream in the alternate scrubber vessel of FIG. 3.

### DETAILED DESCRIPTION

The following detailed description is merely exemplary in nature and is not intended to limit the methods and apparatuses for scrubbing exhaust gases on a ship as claimed herein. Furthermore, there is no intention to be bound by any theory presented in the preceding background or the following detailed description.

As detailed below, the methods and apparatuses for scrubbing exhaust gases on a ship utilize a scrubber vessel that houses both a quench or cooling zone and a scrubbing zone. As a result, the footprint for cooling and scrubbing apparatuses is reduced. Further, the footprint of ducts connecting such apparatuses is eliminated.

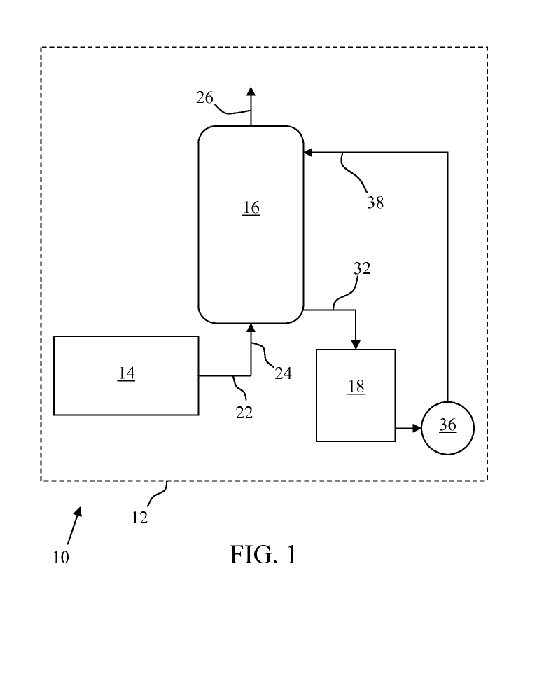

In FIG. 1, a scrubbing apparatus is shown and generally designated 10. The scrubbing apparatus is located on a ship 12 and includes a diesel engine 14, scrubber vessel 16 and secondary basin 18. The diesel engine 14 creates a stream of exhaust gases 22 that are delivered to the scrubber vessel 16 through a duct 24. Scrubbed gases 26 exit the scrubber vessel 16 as shown. While the exemplary scrubber vessel 16 may incorporate any of a variety of means for scrubbing exhaust gases, it is contemplated herein that water, as well as other components to enhance the scrubbing process, is used in the scrubbing process. As shown, water 32 - which may be, for example, sea water—exits the scrubber vessel 16 and flows to the secondary basin 18. The secondary basin 18 is positioned below the scrubber vessel 16 such that water 32 will flow from the scrubber vessel 16 to the secondary basin due to gravity. As shown, the apparatus 10 includes a pump 36 to pump recycled water 38 to the scrubber vessel 16 for reuse in the scrubbing process.

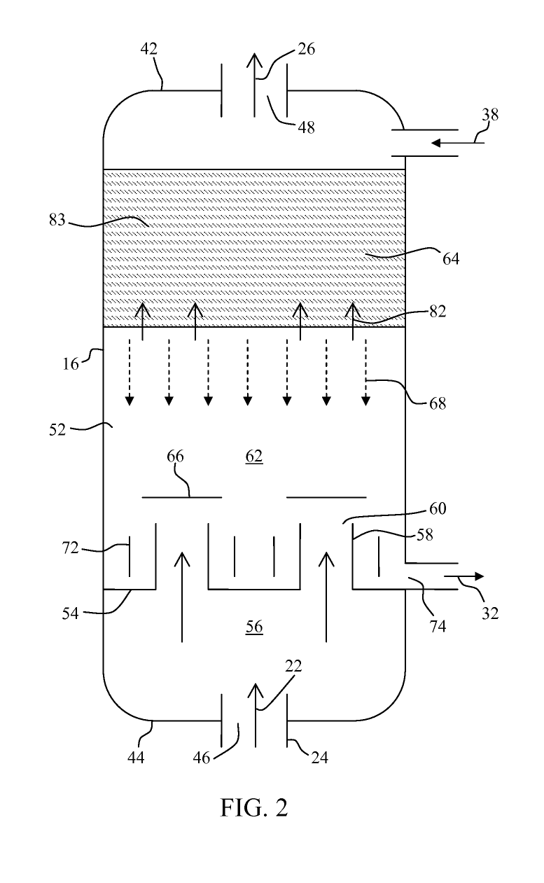

Referring now to FIG. 2, the structure and connections of scrubber vessel 16 may be more specifically explained. As shown, the scrubber vessel 16 has a top end 42 and a bottom end 44. The bottom end 44 is formed with an inlet 46 in communication with the duct 24 to receive the exhaust gases 22 from the diesel engine 14. The top end 42 is formed with an outlet 48 through which the scrubbed gases 26 may exit the scrubber vessel 16.

The scrubber vessel 16 defines a chamber 52. A barrier 54 bounds an inlet zone 56 in the chamber 52 at the bottom end 44 of the vessel 16. Risers 58 pass through the barrier 54 and extend to openings 60 that are positioned in a quench zone 62. While two risers 58 are illustrated, the vessel 16 can be provided with six, eight, or more risers 58 as desired. As shown, the quench zone 62 is bounded by the barrier 54 and a vapor-liquid contact mechanism 64. The exemplary quench zone 62 includes splash or diffusion plates 66. Each plate 66 is positioned at a riser opening 60 to provide a selected flow path to diffuse the flow of exhaust gases 22 into the quench zone 62. Further, the plates 66 block or inhibit falling water drops 68 from entering the risers 58. Typically, any water droplets 68 that enter the risers 58 are atomized and carried back into the quench zone 62 by the flow of exhaust gases 22. The exemplary vessel 16 is further provided with baffles 72 that inhibit movement of any water collected on the barrier 54.

As shown, the vessel 16 is formed with a water outlet 74 adjacent the barrier 54. Water 32 landing on the barrier 54 flows out of the outlet 74 to the secondary basin 18. As a result, water does not rise to the level of the riser openings 60 and does not backflow into the risers 58 toward the engine 14. Such backflow is prevented even in rocking conditions experienced by the ship 12 on rough seas. As noted in FIG. 1, the water 32 received in the secondary basin 18 may be pumped and recycled to the top end 42 of the vessel 16 for reuse in the scrubbing process.

When the exhaust gases 22 enter the quench zone 62, they are typically at a temperature of about 175° C. to about 340° C. (about 350° F. to about 650° F.). Further, the velocity of the exhaust gases 22 from the engine to the vessel 16 is typically in the range of about 2000 feet/minute (ft/min) to about 5000 ft/min. In the quench zone 62, the velocity of the exhaust gases 22 is typically about 2500 ft/min to about 7000 ft/min. The pressure drop of the exhaust gases 22 exiting the diesel engine 14 is typically about 5 inches of water (inH2O) to about 10 inH2O and the pressure drop of the exhaust gases 22 after passing through the plates in the quench zone 62 is about 2 inH2O to about 7 inH2O. Upon impact with the water droplets 68, the exhaust gases atomize the droplets 68 into smaller drops, thereby increasing the surface area of the water. The water cools the exhaust gases 22 to a temperature of about 60° C. to about 70° C. (about 140° F. to about 160° F.), such as about 65° C. (about 150° F.) which is at or near the saturation temperature of the exhaust gases. The water further absorbs sound energy from the exhaust gases 22. In exemplary embodiments, the water removes particulates from the exhaust gases 22.

As shown, the cooled exhaust gases 82 flow from the quench zone 62 into the scrubbing zone 83. The cooled exhaust gases 82 flow in the same direction (upward in FIG. 2) as the flow of the exhaust gases 22 into the inlet zone 56 and quench zone 62. The vapor-liquid contact mechanism 64 scrubs the cooled exhaust gases 82. Mass transfer properties during the scrubbing process are improved due to the reduced temperature of the cooled exhaust gases 82. Specifically, saturating the gases 82 improves mass transfer by reducing the gas volume and by preventing evaporation at the liquid-gas interface that would otherwise reduce mass transfer from the vapor to the liquid. An exemplary vapor-liquid contact mechanism 64 is a packed bed, with plastic or metal packing It is noted that due to the improved mass transfer properties, a wider variety of packings may be used to sufficiently scrub the cooled exhaust gases 82. After scrubbing, the scrubbed gases 26 exit the vessel 16 through the outlet 48.

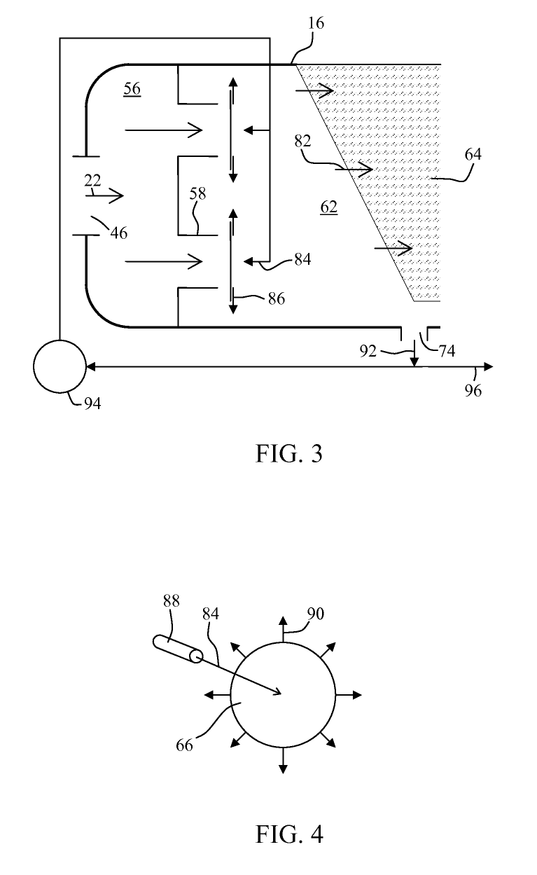

Referring to FIG. 3, an alternate arrangement is illustrated. As shown, the exhaust gases 22 enter the vessel 16 through a horizontal inlet 46. The exhaust gases 22 pass through the inlet zone 56 and horizontal risers 58 into the quench zone 62. In the quench zone 62, water streams 84 are directed at the plates 66 with sufficient velocity to form a layer 86 of water extending radially away from the plates 66. This is shown more clearly in FIG. 4. In FIG. 4, the exemplary water stream 84 is directed at the disk-shaped plate 66 by a tube 88. As the water stream 84 contacts the plate 66, it forms into a layer 86 of water. The layer of water 86 flows out past the edge of the plate 66 in the direction of radial arrows 90.

Referring back to FIG. 3, the exhaust gases 22 entering the quench zone 62 are diffused by the plate 66 and pass through the layer 86 of water. Upon impact with the water 86, the exhaust gases 22 atomize the water 86 into small droplets. As in the vessel 16 of FIG. 2, the exhaust gases 22 are cooled, such as from about 175° C. to about 340° C. to near the gases' saturation temperature, such as about 60° C. to about 70° C., for example, about 65° C. The cooled exhaust gases 82 then pass into the vapor-liquid contact mechanism 64 in the scrubbing zone 83. Water exits the vessel 16 through water outlet 74. As shown, the exiting water 92 may be recycled to a pump 94 and pumped for reuse in the quench zone 62, or recycled to the pump 36 (shown in FIG. 1), and reused in the vapor-liquid contact mechanism 64, as indicated by arrow 96.

While the particular methods and apparatuses for scrubbing diesel exhaust gases on a ship as herein shown and disclosed in detail are fully capable of obtaining the objects and providing the advantages herein before stated, it is to be understood that they are merely illustrative of exemplary embodiments and that no limitations are intended to the details of construction or design herein shown other than as described in the appended claims.

What is claimed is:

1. A method for scrubbing diesel exhaust gases produced on a ship comprising:
providing a scrubber vessel formed with a quench zone, a scrubbing zone, and a riser;
passing water through the scrubbing zone and into the quench zone;
delivering the exhaust gases to the quench zone through the riser, wherein the exhaust gases enter the quench zone at a temperature of about 175° C. to about 340° C.;
cooling the exhaust gases to a temperature of about 60° C. to about 70° C. in the quench zone by contacting the exhaust gases with the water; and
scrubbing the cooled exhaust gases in the scrubbing zone.

2. The method of claim 1 wherein the scrubber vessel is formed with a plate shielding the riser, and further comprising inhibiting flow of water into the riser with the plate.

3. The method of claim 2 further comprising diffusing the flow of the exhaust gases into the quench zone with the plate.

4. The method of claim 1 further comprising absorbing sound energy from the exhaust gases into the water in the quench zone.

5. The method of claim 1 wherein cooling comprises atomizing the water with the exhaust gases.

6. The method of claim 1 wherein the scrubbing zone includes a packed bed, and wherein the water passes into the quench zone in the form of droplets.

7. The method of claim 1 wherein the exhaust gases are flowed in a direction through the quench zone and flowed in the direction through the scrubbing zone.

8. The method of claim 1 further comprising removing the water from the quench zone out of the scrubber vessel and recycling the removed water into the scrubber vessel upstream of the scrubbing zone.

9. The method of claim 1 further comprising positioning a secondary basin below the scrubber vessel and gravity-flowing the water out of the quench zone and into the secondary basin.

10. The method of claim 1 wherein the exhaust gases are delivered to the quench zone at a velocity of about 2000 to about 5000 ft/min.

11. A method for scrubbing diesel exhaust gases produced on a ship comprising:
flowing the exhaust gases from a diesel engine to a scrubber vessel;
introducing the exhaust gases to a chamber within the scrubber vessel, wherein the exhaust gases have a temperature of about 175° C. to about 340° C.;
cooling the exhaust gases to a temperature of about 60° C. to about 70° C.; and
scrubbing the cooled exhaust gases.

12. The method of claim 11 wherein a liquid-vapor contact mechanism scrubs the cooled exhaust gases.

13. The method of claim 12 wherein water exiting the liquid-vapor contact mechanism cools the exhaust gases.

14. The method of claim 13 further comprising absorbing sound energy from the exhaust gases into the water.

15. The method of claim 13 wherein the exhaust gases flow in a single direction during cooling and scrubbing.

16. The method of claim 13 further comprising removing the water from the scrubber vessel and recycling the removed water into the scrubber vessel upstream of the liquid-vapor contact mechanism.

17. The method of claim 13 further comprising positioning a secondary basin below the scrubber vessel and gravity-flowing the water out of the quench zone and into the secondary basin.

18. The method of claim 13 wherein the exhaust gases are introduced to the chamber through a riser, and further comprising inhibiting flow of the water into the riser with a plate.

19. The method of claim 13 wherein the exhaust gases are introduced to the chamber through a riser at a velocity of about 2000 to about 5000 ft/min.

20. An apparatus for scrubbing diesel exhaust gases produced on a ship comprising:
a scrubber vessel formed with a quench zone, a scrubbing zone, and a riser;
a duct configured to deliver the exhaust gases through the riser and into the quench zone at a temperature of about 175° C. to about 340° C.;
a means for cooling the exhaust gases to about 60° C. to about 70° C. in the quench zone; and
a means for scrubbing the cooled exhaust gases in the scrubbing zone.
